(19) United States
(12) Patent Application Publication
(10) Pub. No.: US 2026/0320970 A1
(43) Pub. Date: Oct. 15, 2026

(54) INFORMATION PROCESSING DEVICE, RECORDING MEDIUM, AND INFORMATION PROCESSING METHOD

(71) Applicant: NEC Corporation, Tokyo (JP)

(72) Inventors: Tomokazu KANEKO, Tokyo (JP); Kazuki ISHIYAMA, Tokyo (JP)

(73) Assignee: NEC Corporation, Tokyo (JP)

(21) Appl. No.: 19/462,033

(22) Filed: Jan. 28, 2026

(30) Foreign Application Priority Data
Feb. 21, 2025 (JP) 2025-027136

(51) Int. Cl. G06V 10/74; G06T 5/50; G06T 7/11

(52) U.S. Cl. CPC G06V 10/761; G06T 5/50; G06T 7/11; G06T 2207/20221

(57) ABSTRACT

An information processing device includes, at least one memory storing instructions, and at least one processor configured to execute the instructions to, calculate, for each one of a plurality of representation indexes that represent regions included in an image and based on objects that appear in the image, each of the representation indexes having a different value, a degree of similarity with each of other representation indexes included in the plurality of representation indexes, form a group of the representation indexes in which the degree of similarity is higher than a predetermined threshold, determine a representative point of the group by using the representation indexes in the group, and determine a representative representation index based on the representative point.

This application is based upon and claims the benefit of priority from Japanese Patent Application No. 2025-027136, filed on Feb. 21, 2025, the disclosure of which is incorporated herein in its entirety by reference.

### TECHNICAL FIELD

The present disclosure relates to an information processing device, a recording medium, and an information processing method.

### BACKGROUND ART

JP 2012-190089 A describes an image analysis device. This image analysis device extracts a large number of feature points from an image to be analyzed, analyzes a spatial distribution of feature points having similar local features among the feature points, and estimates a rough position of an object to be recognized based on a density of the distribution. Then, the image analysis device performs matching with an image for reference again in a region surrounding a region obtained by the position estimation, and identifies the object to be recognized. Then, the image analysis device associates identification information of the object based on a reference image obtained as a result with position information of the object in the image to be analyzed.

### SUMMARY

A technology described in JP 2012-190089 A requires a reference image for recognition of an object in an image to be analyzed.

The present disclosure has been made in view of the above problem, and an object of the present disclosure is to provide a technology capable of recognizing an object in an image without using a reference image.

An information processing device according to one illustrative aspect of the present disclosure includes: a calculation means for calculating, for each one of a plurality of representation indexes that represent regions included in an image and based on objects that appear in the image, each of the representation indexes having a different value, a degree of similarity with each of other representation indexes included in the plurality of representation indexes; a grouping means for forming a group of the representation indexes in which the degree of similarity is higher than a predetermined threshold; and a determination means for determining a representative point of the group by using the representation indexes in the group, and determining a representative representation index based on the representative point.

A program according to one illustrative aspect of the present disclosure causes at least one processor to execute: calculation processing of calculating, for each one of a plurality of representation indexes that represent regions included in an image and based on objects that appear in the image, each of the representation indexes having a different value, a degree of similarity with each of other representation indexes included in the plurality of representation indexes; grouping processing of forming a group of the representation indexes in which the degree of similarity is higher than a predetermined threshold; and determination processing of determining a representative point of the group by using the representation indexes in the group, and determining a representative representation index based on the representative point.

An information processing method according to one illustrative aspect of the present disclosure includes: a calculation step of calculating, by at least one processor, for each one of a plurality of representation indexes that represent regions included in an image and based on objects that appear in the image, each of the representation indexes having a different value, a degree of similarity with each of other representation indexes included in the plurality of representation indexes; a grouping step of forming, by the at least one processor, a group of the representation indexes in which the degree of similarity is higher than a predetermined threshold; and a determination step of determining, by the at least one processor, a representative point of the group by using the representation indexes in the group, and determining a representative representation index based on the representative point.

According to one illustrative aspect of the present disclosure, it is possible to recognize an object in an image without using a reference image.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating an example of a functional configuration of an information processing device according to a first illustrative example embodiment of the present disclosure;

FIG. 2 is a flowchart illustrating an example of a flow of an information processing method according to the first illustrative example embodiment of the present disclosure;

FIG. 3 is a block diagram illustrating an example of a functional configuration of an information processing device according to a second illustrative example embodiment of the present disclosure;

FIG. 4A, FIG. 4B, and FIG. 4C are diagrams illustrating an example of processing performed by the information processing device;

FIG. 5 is a diagram illustrating an example of the processing performed by the information processing device;

FIG. 6 is a diagram illustrating an example of the processing performed by the information processing device;

FIG. 7 is a diagram illustrating an example of the processing performed by the information processing device;

FIG. 8 is a flowchart illustrating an example of a flow of an information processing method according to the second illustrative example embodiment of the present disclosure; and

FIG. 9 is a block diagram illustrating a hardware configuration of a computer that functions as the information processing device according to the present disclosure.

### EXAMPLE EMBODIMENT

Hereinafter, example embodiments of the present disclosure will be exemplified. However, the present disclosure is not limited to illustrative example embodiments described below, and various changes may be made without departing from the spirit and scope as defined by the claims. For example, example embodiments obtained by appropriately combining technical means adopted in the illustrative example embodiments described below may also fall within the scope of the present disclosure. Example embodiments obtained by appropriately omitting some of the technical means adopted in the illustrative example embodiments described below may also fall within the scope of the present disclosure. Effects described in the illustrative example embodiments described below are examples of effects expected in the illustrative example embodiments, and do not define extension of the present disclosure. That is, example embodiments that do not exert the effects described in the illustrative example embodiments described below may also fall within the scope of the present disclosure.

### First Illustrative Example Embodiment

First, a first illustrative example embodiment, which is an example of the example embodiments of the present disclosure, will be described in detail with reference to the drawings. The present illustrative example embodiment is a basic form of the illustrative example embodiments described below. An application range of each technical means adopted in the present illustrative example embodiment is not limited to the present illustrative example embodiment. That is, each technical means adopted in the present illustrative example embodiment can also be adopted in the other illustrative example embodiment included in the present disclosure as long as no particular technical problem occurs. Each technical means illustrated in the drawings referred to for describing the present illustrative example embodiment can also be adopted in the other illustrative example embodiment included in the present disclosure as long as no particular technical problem occurs.

### (Configuration of Information Processing Device 1)

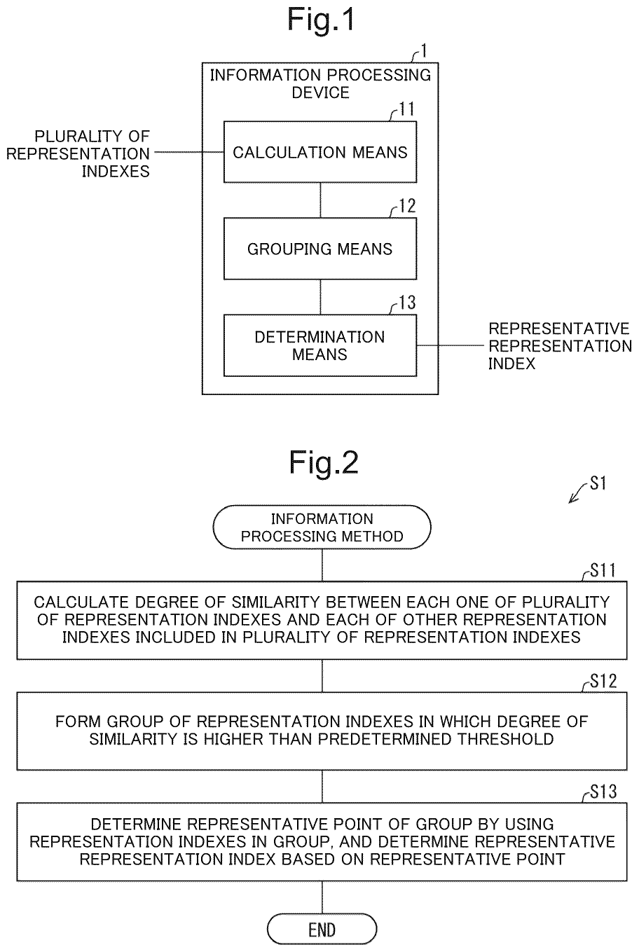

First, a configuration of an information processing device 1 will be described with reference to FIG. 1. FIG. 1 is a block diagram illustrating the configuration of the information processing device 1. As illustrated in FIG. 1, the information processing device 1 includes a calculation means 11, a grouping means 12, and a determination means 13.

### Calculation Means 11

The calculation means 11 calculates a degree of similarity between each one of a plurality of representation indexes and each of other representation indexes included in the plurality of representation indexes. The “representation indexes” represent regions included in an image and based on objects that appear in the image, and each representation index has a different value. The “objects that appear in the image” are objects to be recognized by a means (e.g., trained model) for recognizing (extracting) the image, and do not include a background. The number of objects that appear in the image may be one, or may be more than one. The “regions based on objects” may include an object region indicating an object and a background region indicating the background, which are separated by an outline of the object. The “regions based on objects” may include a region indicating a part of an object or a background, a region collectively indicating a plurality of objects, and the like.

### Grouping Means 12

The grouping means 12 forms a group of representation indexes in which the degree of similarity is higher than a predetermined threshold. The grouping means 12 may create one group, or may create more than one group.

### Determination Means 13

The determination means 13 determines a representative point of a group by using representation indexes in the group, and determines a representative representation index based on the representative point. The “representative point” includes a point indicating a centroid of the group, a point indicating the center (middle) of the group, a point indicated by a statistical value (e.g., average value) of the representation indexes, and the like.

### (Effect of Information Processing Device 1)

The information processing device 1 described above adopts a configuration in which the grouping means 12 forms a group of representation indexes in which the degree of similarity is higher than a predetermined threshold. The information processing device 1 adopts a configuration in which the determination means 13 determines a representative point of a group by using representation indexes in the group, and determines a representative representation index based on the representative point. The representative representation index is a representation index that most appropriately represents an object or a background in an image. Thus, according to the information processing device 1 according to the present example embodiment, it is possible to obtain an effect of allowing for recognition of an object in an image without using a reference image.

### (Flow of Information Processing Method S1)

Next, a flow of an information processing method S1 will be described with reference to FIG. 2. FIG. 2 is a flowchart illustrating the flow of the information processing method S1. As illustrated in FIG. 2, the information processing method S1 includes a calculation step S11, a grouping step S12, and a determination step S13.

### Calculation Step S11

In the calculation step S11, at least one processor calculates the degree of similarity between each one of a plurality of representation indexes and each of other representation indexes included in the plurality of representation indexes. The processor that calculates the degree of similarity may be included in the information processing device 1, or may be included in another device.

### Grouping Step S12

The calculation step S11 is followed by the grouping step S12. In the grouping step S12, the at least one processor forms a group of representation indexes in which the degree of similarity is higher than a predetermined threshold. The processor that forms a group of representation indexes may be included in the information processing device 1, or may be included in another device.

### Determination Step S13

The grouping step S12 is followed by the determination step S13. In the determination step S13, the at least one processor determines a representative point of a group by using representation indexes in the group, and determines a representative representation index based on the representative point. The processor that determines the representative representation index may be included in the information processing device 1, or may be included in another device. The processor that determines the representative point of the group and the processor that determines the representative representation index may be the same, or may be different.

### (Effect of Information Processing Method S1)

As described above, the information processing method S1 adopts a configuration in which the at least one processor forms a group of representation indexes in which the degree of similarity is higher than a predetermined threshold in the grouping step S12. The information processing method S1 adopts a configuration in which a representative point of a group is determined by using representation indexes in the group, and a representative representation index based on the representative point is determined in the determination step S13. The representative representation index is a representation index that most appropriately represents an object or a background in an image. Thus, according to the information processing method S1 according to the first illustrative example embodiment, it is possible to obtain an effect of allowing for recognition of an object in an image without using a reference image.

### Second Illustrative Example Embodiment

Next, a second illustrative example embodiment, which is an example of the example embodiments of the present disclosure, will be described in detail with reference to the drawings. Components having the same functions as the components described in the above-described illustrative example embodiment are denoted by the same reference signs, and the description thereof will be appropriately omitted. An application range of each technical means adopted in the present illustrative example embodiment is not limited to the present illustrative example embodiment. That is, each technical means adopted in the present illustrative example embodiment can also be adopted in the other illustrative example embodiment included in the present disclosure as long as no particular technical problem occurs. Each technical means illustrated in each of the drawings referred to for describing the present illustrative example embodiment can be adopted in the other illustrative example embodiment included in the present disclosure as long as no particular technical problem occurs.

### (Configuration of Information Processing Device 1A)

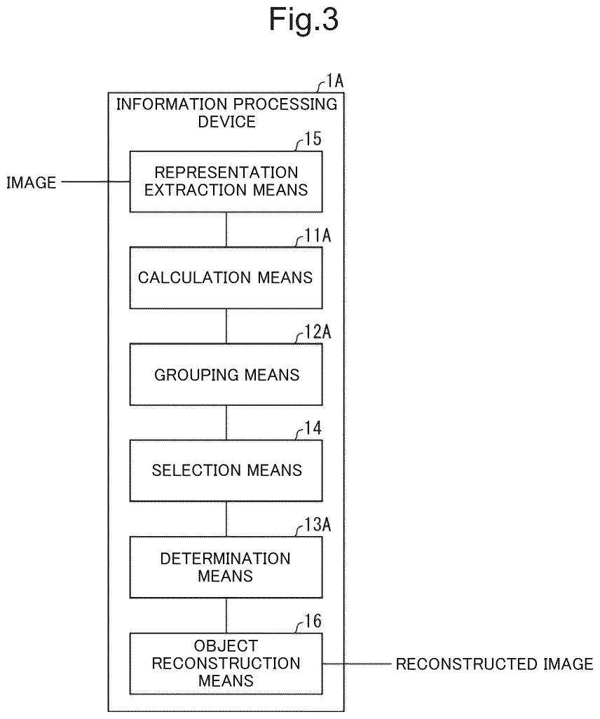

First, a configuration of an information processing device 1A according to the second illustrative example embodiment will be described with reference to FIG. 3. FIG. 3 is a block diagram illustrating the configuration of the information processing device 1A according to the second illustrative example embodiment. The information processing device 1A according to the second illustrative example embodiment includes a calculation means 11A, a grouping means 12A, and a determination means 13A. The information processing device 1A according to the second illustrative example embodiment further includes a selection means 14, a representation extraction means 15, and an object reconstruction means 16.

### Representation Extraction Means 15

The representation extraction means 15 generates a plurality of representation indexes based on an image. The representation extraction means 15 according to the second illustrative example embodiment first divides the image into as many regions as a slot count. The “slot count” is a value indicating the number of regions when an image is divided into regions of individual objects and a background region. The “number of backgrounds” may be one, or may be equal to or more than two. The representation extraction means 15 according to the second illustrative example embodiment divides the image into as many regions as the slot count by using, for example, an object-centric world model. Then, the representation extraction means 15 generates a representation index of each of the divided regions. Representation indexes generated by the representation extraction means 15 according to the second illustrative example embodiment are representation vectors. Various conventionally known methods can be used to calculate the representation vectors.

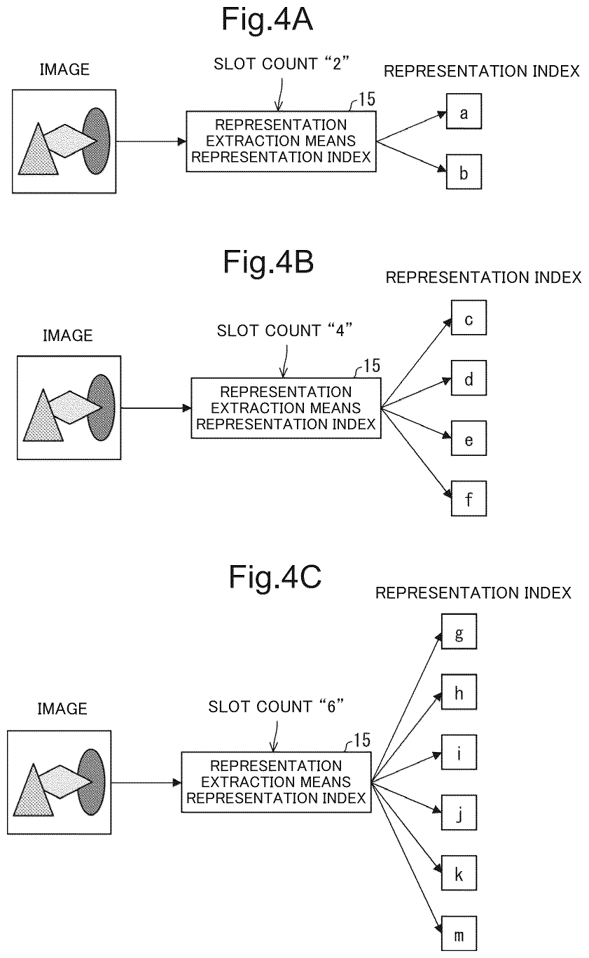

The representation extraction means 15 according to the second illustrative example embodiment first acquires, for one image, a list including at least a first slot count and a second slot count different from the first slot count. That is, the representation extraction means 15 according to the second illustrative example embodiment obtains the slot counts from the list. The list may include a third slot count, . . . , and an n-th slot count. The representation extraction means 15 may be configured to acquire the slot counts by a method other than the list (for example, input by a user). Then, the representation extraction means 15 divides the image into as many regions as the first slot count, and generates a representation index of each of the divided regions. Furthermore, the representation extraction means 15 divides the image into as many regions as the second slot count, and generates a representation index of each of the divided regions. In a case where the third to n-th slot counts are included in the list acquired by the representation extraction means 15, the representation extraction means 15 divides the image into as many regions as the third to n-th slot counts, and also generates a representation index of each of the divided regions. For example, it is assumed that the first slot count=2, the second slot count=4, and the third slot count=6 are included in the list acquired by the representation extraction means 15. In this case, as illustrated in FIG. 4A, FIG. 4B, and FIG. 4C, the representation extraction means 15 generates, for one image, two representation indexes a and b based on the first slot count, four representation indexes c, d, e, and f based on the second slot count, and six representation indexes g, h, i, j, k, and m based on the third slot count. That is, in a case where the slot count list is L=[K₁, K₂, . . . , K₁], the total number N of representation indexes generated for one image by the representation extraction means 15 is expressed by the following Math. 1.

$$N = {\sum }_{i = 1}^{I} {K}_{i} \qquad [ Math . 1 ]$$

### Calculation Means 11A

Similarly to the calculation means 11 according to the first illustrative example embodiment, the calculation means 11A calculates the degree of similarity between each one of a plurality of representation indexes and each of other representation indexes included in the plurality of representation indexes. As described above, the representation indexes generated by the representation extraction means 15 are representation vectors. Thus, the calculation means 11A according to the second illustrative example embodiment calculates a cosine similarity as the degree of similarity. The calculation means 11A may be configured to calculate a deviation pattern similarity, a correlation coefficient, or the like as the degree of similarity, instead of the cosine similarity.

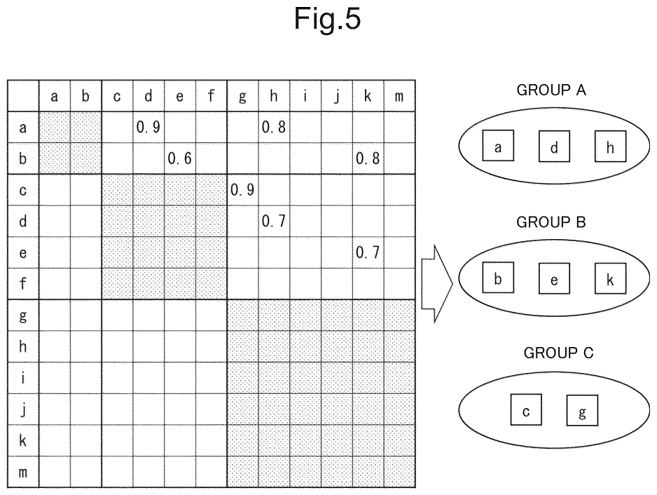

The calculation means 11A according to the second illustrative example embodiment calculates the degrees of similarity (cosine similarities) between the representation indexes generated based on the first slot count and the representation indexes generated based on the second slot count. In a case where the third to n-th slot counts are included in the list acquired by the representation extraction means, the calculation means 11A also calculates the degrees of similarity between the representation indexes generated based on the first slot count and the representation indexes generated based on the third to n-th slot counts. In this case, the calculation means 11A further calculates the degrees of similarity between the representation indexes generated based on the second slot count and the representation indexes generated based on the third to n-th slot counts, . . . , and the degrees of similarity between the representation indexes generated based on the n−1-th slot count and the representation indexes generated based on the n-th slot count. For example, it is assumed that the representation extraction means 15 has generated, for one image, two representation indexes a and b based on the first slot count, four representation indexes c, d, e, and f based on the second slot count, and six representation indexes g, h, i, j, k, and m based on the third slot count. In this case, the calculation means 11A calculates the degrees of similarity between the representation index a and the representation indexes c to m, the degrees of similarity between the representation index b and the representation indexes c to m, the degrees of similarity between the representation index c and the representation indexes g to m, and the degrees of similarity between the representation index f and the representation indexes g to m. A matrix on the left side of FIG. 5 illustrates calculation results of some of the degrees of similarity. The calculation means 11A may be configured to calculate the degree of similarity between representation indexes (for example, the representation index a and the representation index b) generated based on the same slot count.

### Grouping Means 12A

Similarly to the grouping means 12 according to the first illustrative example embodiment, the grouping means 12A forms a group of representation indexes in which the degree of similarity is higher than a predetermined threshold. As described above, the calculation means 11A calculates the cosine similarity. Thus, the grouping means 12A according to the second illustrative example embodiment forms a group of the representation indexes in which the cosine similarity is higher than a predetermined threshold (for example, 0.5). The threshold may be set by a user, or may be determined based on evaluation data. For example, in the case of the example illustrated in FIG. 5, the degree of similarity between the representation index a and the representation index d is 0.9, the degree of similarity between the representation index a and the representation index h is 0.8, and the degree of similarity between the representation index h and the representation index d is 0.7. Thus, the grouping means 12A creates a group A including the representation indexes a, d, and h. The grouping means 12A according to the second illustrative example embodiment creates a plurality of groups. Thus, the grouping means 12A also creates a group B including the representation indexes b, e, and k, a group C including the representation indexes c and g, and the like.

### Selection Means 14

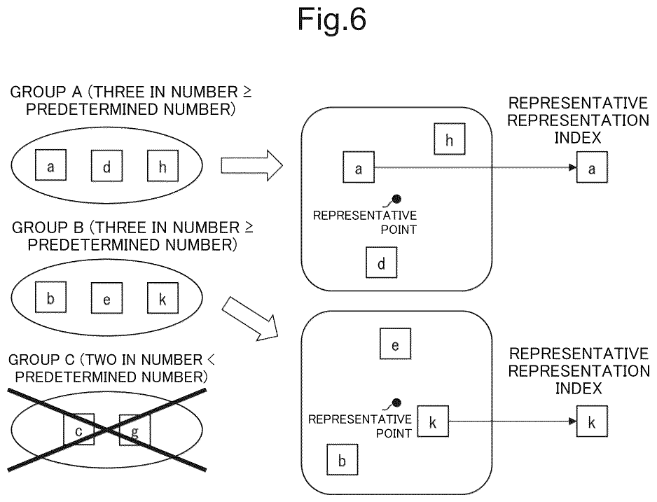

The selection means 14 selects a group in which the number of representation indexes included in the group is equal to or more than a predetermined number (for example, three) from among the plurality of groups. For example, as illustrated on the left side of FIG. 6, the selection means 14 selects the groups A and B in which the number of included representation indexes is three, and does not select the group C in which the number of included representation indexes is two.

### Determination Means 13A

Similarly to the determination means 13 according to the first illustrative example embodiment, the determination means 13A according to the second illustrative example embodiment determines a representative point of a group by using representation indexes in the group, and determines a representative representation index based on the representative point. The determination means 13A according to the second illustrative example embodiment determines a representative point of a group selected by the selection means 14. As described above, the representation indexes generated by the representation extraction means 15 are representation vectors. Thus, the determination means 13A according to the second illustrative example embodiment calculates, as the representative point, a centroid vector representing a centroid of the group. The determination means 13A according to the second illustrative example embodiment determines, as the representative representation index, the representation index closest to the representative point from among a plurality of representation indexes included in the group. For example, it is assumed that the selection means 14 has selected the group A including the representation indexes a, d, and h and the group B including the representation indexes b, e, and k. Then, it is assumed that the position indicated by each representation index (representation vector) in a coordinate space and the position indicated by the centroid vector are as illustrated in the center of FIG. 6. In this case, the determination means 13A determines the representation index a, which is closest to the representative point, as the representative representation index for the group A, and determines the representation index k, which is closest to the representative point, as the representative representation index for the group B. The determination means 13A may be configured to determine the representative point as the representative representation index.

### Object Reconstruction Means 16

The object reconstruction means 16 generates a layer in which an object appears based on a representative representation index.

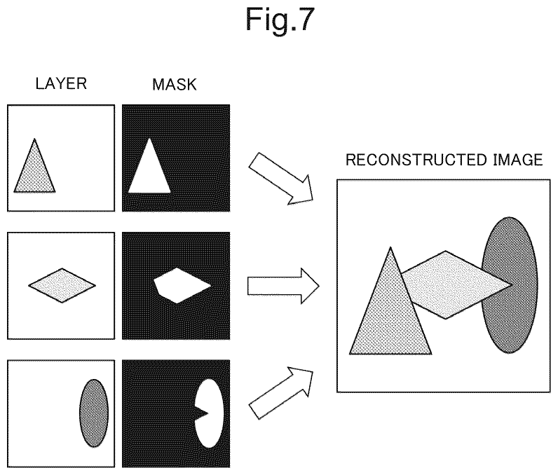

The object reconstruction means 16 according to the second illustrative example embodiment generates layers in which objects represented by representative representation indexes appear and masks corresponding to the layers as illustrated in FIG. 7. In a case where a plurality of representative representation indexes has been determined by the determination means 13A, the object reconstruction means 16 generates a set of a layer and a mask for each of the representative representation indexes representing layers. In a case where a part of a certain object is positioned behind another object, the object reconstruction means 16 generates a layer in which the entire certain object appears and a mask that hides the portion positioned behind the another object. Then, the object reconstruction means 16 generates a reconstructed image in which the layer in which the object appears and a background layer are superimposed.

### (Effect of Information Processing Device 1A)

According to the information processing device 1A described above, it is possible to obtain effects similar to those of the information processing device 1 according to the first illustrative example embodiment. That is, it is possible to obtain an effect of allowing for recognition of an object in an image without using a reference image.

The information processing device 1A adopts a configuration in which the representation extraction means 15 divides an image into as many regions as the first to n-th slot counts, and generates a representation index of each of the divided regions. That is, the information processing device 1A divides a region by various slot counts, and determines representative representation indexes based on various representation indexes generated therefrom. In conventional object recognition, it has been necessary to set in advance an appropriate slot count in accordance with the number of objects in an image. In a case where the slot count is too large (too small) with respect to the actual number of objects, over-division (no detection) of an object region may occur. However, according to the information processing device 1A, it is also possible to obtain an effect of allowing for acquisition of a slot count appropriate for an image just by inputting the image.

### (Flow of Information Processing Method S1A)

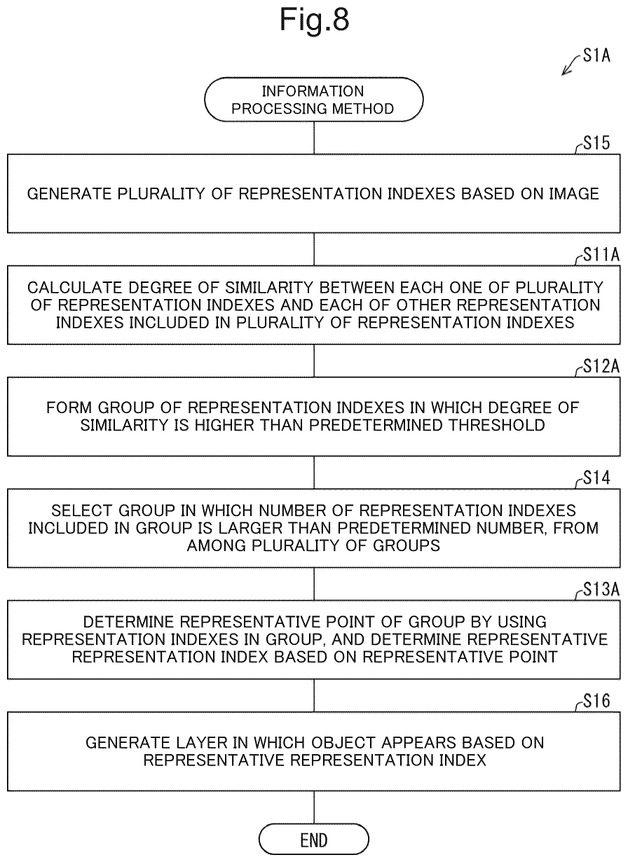

Next, a flow of an information processing method S1A according to the second illustrative example embodiment will be described with reference to FIG. 8. FIG. 8 is a flowchart illustrating the flow of the information processing method S1A according to the second illustrative example embodiment. As illustrated in FIG. 8, the information processing method S1A according to the second illustrative example embodiment includes a calculation step S11A, a grouping step S12A, and a determination step S13A. The information processing method S1A according to the second illustrative example embodiment further includes a selection step S14, a representation extraction step S15, and an object reconstruction step S16.

### Representation Extraction Step S15

In the first representation extraction step S15, at least one processor generates a plurality of representation indexes based on an image. In the representation extraction step S15 according to the second illustrative example embodiment, the at least one processor first divides the image into as many regions as the slot count. The processor that divides an image into regions may be included in the information processing device 1A, or may be included in another device. In the representation extraction step S15 according to the second illustrative example embodiment, the at least one processor divides the image into as many regions as the slot count by using, for example, an object-centric world model. Then, in the representation extraction step S15, the at least one processor generates a representation index of each of the divided regions. The processor that generates representation indexes may be included in the information processing device 1A, or may be included in another device. Representation indexes generated by the at least one processor in the representation extraction step S15 according to the second illustrative example embodiment are representation vectors. Various conventionally known methods can be used to calculate the representation vectors.

In the representation extraction step S15 according to the second illustrative example embodiment, the at least one processor first acquires, for one image, a list including at least a first slot count and a second slot count different from the first slot count. That is, in the representation extraction step S15 according to the second illustrative example embodiment, the at least one processor obtains the slot counts from the list. The list may include a third slot count, . . . , and an n-th slot count.

In the representation extraction step S15, the at least one processor may acquire the slot counts by a method other than the list (for example, input by a user). Then, in the representation extraction step S15, the at least one processor divides the image into as many regions as the first slot count, and generates a representation index of each of the divided regions. Furthermore, in the representation extraction step S15, the at least one processor divides the image into as many regions as the second slot count, and generates a representation index of each of the divided regions. In a case where the third to n-th slot counts are included in the list acquired by the at least one processor in the representation extraction step S15, the at least one processor divides the image into as many regions as the third to n-th slot counts, and also generates a representation index of each of the divided regions in the representation extraction step S15.

### Calculation Step S11A

The representation extraction step S15 is followed by the calculation step S11A. In the calculation step S11A, similarly to the calculation step S11 according to the first illustrative example embodiment, the at least one processor calculates the degree of similarity between each one of a plurality of representation indexes and each of other representation indexes included in the plurality of representation indexes. The processor that calculates the degree of similarity may be included in the information processing device 1A, or may be included in another device. As described above, the representation indexes generated by the at least one processor in the representation extraction step S15 are representation vectors.

Thus, in the calculation step S11A according to the second illustrative example embodiment, the at least one processor calculates a cosine similarity as the degree of similarity. In the calculation step S11A, the at least one processor may calculate, as the degree of similarity, an index other than the cosine similarity.

In the calculation step S11A according to the second illustrative example embodiment, the at least one processor calculates the degrees of similarity (cosine similarities) between the representation indexes generated based on the first slot count and the representation indexes generated based on the second slot count. There is a case where the third to n-th slot counts are included in the list acquired by the at least one processor in the representation extraction step S15. In this case, in the calculation step S11A, the at least one processor also calculates the degrees of similarity between the representation indexes generated based on the first slot count and the representation indexes generated based on the third to n-th slot counts. In this case, in the calculation step S11A, the degrees of similarity between the representation indexes generated based on the second slot count and the representation indexes generated based on the third to n-th slot counts, . . . , and the degrees of similarity between the representation indexes generated based on the n−1-th slot count and the representation indexes generated based on the n-th slot count are further calculated. In the calculation step S11A, the at least one processor may calculate the degree of similarity between representation indexes generated based on the same slot count.

### Grouping Step S12A

The calculation step S11A is followed by the grouping step S12A. In the grouping step S12A, similarly to the grouping step S12 according to the first illustrative example embodiment, the at least one processor forms a group of representation indexes in which the degree of similarity is higher than a predetermined threshold. The processor that forms a group of representation indexes may be included in the information processing device 1A, or may be included in another device. As described above, in the calculation step S11A, the at least one processor calculates cosine similarities. Thus, in the grouping step S12A according to the second illustrative example embodiment, the at least one processor forms a group of representation indexes in which the cosine similarity is higher than a predetermined threshold (for example, 0.5).

The threshold may be set by a user, or may be determined based on evaluation data.

### Selection Step S14

The grouping step S12A is followed by the selection step S14. In the selection step S14, the at least one processor selects a group in which the number of representation indexes included in the group is equal to or more than a predetermined number (for example, three) from among a plurality of groups. The processor that selects a group may be included in the information processing device 1A, or may be included in another device.

### Determination Step S13A

The selection step S14 is followed by the determination step S13A. In the determination step S13A according to the second illustrative example embodiment, similarly to the determination step S13 according to the first illustrative example embodiment, the at least one processor determines a representative point of a group by using representation indexes in the group, and determines a representative representation index based on the representative point. The processor that determines a representative representation index may be included in the information processing device 1A, or may be included in another device. The processor that determines the representative point of the group and the processor that determines the representative representation index may be the same, or may be different. In the determination step S13A according to the second illustrative example embodiment, the at least one processor determines the representative point of the group selected in the selection step S14. As described above, the representation indexes generated by the at least one processor in the representation extraction step S15 are representation vectors. Thus, in the determination step S13A according to the second illustrative example embodiment, the at least one processor calculates a centroid vector as the representative point. In the determination step S13A according to the second illustrative example embodiment, the at least one processor determines, as the representative representation index, the representation index closest to the representative point from among a plurality of representation indexes included in the group. In the determination step S13A, the at least one processor may determine the representative point as the representative representation index.

### Object Reconstruction Step S16

The determination step S13A is followed by the object reconstruction step S16. In the object reconstruction step S16, the at least one processor generates a layer in which an object appears based on the representative representation index. The processor that generates a layer may be included in the information processing device 1A, or may be included in another device. In the object reconstruction step S16 according to the second illustrative example embodiment, the at least one processor generates layers in which objects represented by representative representation indexes appear and masks corresponding to the layers. In a case where a plurality of representative representation indexes has been determined by the at least one processor in the determination step S13A, a set of a layer and a mask is generated for each of the representative representation indexes representing layers in the object reconstruction step S16. In the object reconstruction step S16, in a case where a part of a certain object is positioned behind another object, the at least one processor generates a layer in which the entire certain object appears and a mask that hides the portion positioned behind the another object. Then, in the object reconstruction step S16, the at least one processor generates a reconstructed image in which the layer in which the object appears and a background layer are superimposed. The processor that generates a reconstructed image may be included in the information processing device 1A, or may be included in another device.

### (Effect of Information Processing Method S1A)

According to the information processing method S1A described above, it is possible to obtain an effect similar to that of the information processing method S1 according to the first illustrative example embodiment. That is, it is possible to obtain an effect of allowing for recognition of an object in an image without using a reference image.

The information processing method S1A employs a configuration in which, in the representation extraction step S15, the at least one processor divides an image into as many regions as the first to n-th slot counts, and generates a representation index of each of the divided regions. That is, in the information processing method S1A, a region is divided by various slot counts, and representative representation indexes are determined based on various representation indexes generated therefrom. In conventional object recognition, it has been necessary to set in advance an appropriate slot count in accordance with the number of objects in an image. In a case where the slot count is too large (too small) with respect to the actual number of objects, over-division (no detection) of an object region may occur. However, according to the information processing method S1A, it is also possible to obtain an effect of allowing for acquisition of a slot count appropriate for an image just by inputting the image.

### [Example of Implementation by Software]

Some or all of the functions of the information processing devices 1 and 1A (which will also be hereinafter referred to as “each of the above devices”) may be implemented by hardware such as an integrated circuit (IC chip), or may be implemented by software.

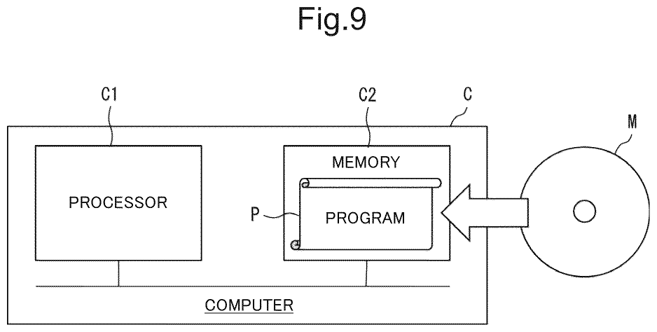

In the latter case, each of the above devices is implemented by, for example, a computer that executes commands of a program, which is software for implementing each function. FIG. 9 illustrates an example of such a computer (hereinafter, referred to as a computer C). FIG. 9 is a block diagram illustrating a hardware configuration of the computer C functioning as each of the above devices.

The computer C includes at least one processor C1 and at least one memory C2. A program P for causing the computer C to operate as each piece of the above means is recorded in the memory C2. In the computer C, the processor C1 reads the program P from the memory C2 and executes the program P, thereby implementing each function of the means described above.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, a combination thereof, or the like can be used. As the memory C2, for example, a flash memory, a hard disk drive (HDD), a solid state drive (SSD), a combination thereof, or the like can be used.

The computer C may further include a random access memory (RAM) for loading the program P at the time of execution and temporarily storing various types of data. The computer C may further include a communication interface for sending and receiving data to and from another device. The computer C may further include an input/output interface for connecting input/output equipment such as a keyboard, a mouse, a display, and a printer.

The program P can be recorded on a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

### [Supplementary Information 1]

The present disclosure includes the technologies described in the following Supplementary Notes. However, the present disclosure is not limited to the technologies described in the following Supplementary Notes, and various changes may be made without departing from the spirit and scope as defined by the claims.

### (Supplementary Note 1)

An information processing device including:
a calculation means for calculating, for each one of a plurality of representation indexes that represent regions included in an image and based on objects that appear in the image, each of the representation indexes having a different value, a degree of similarity with each of other representation indexes included in the plurality of representation indexes;
a grouping means for forming a group of the representation indexes in which the degree of similarity is higher than a predetermined threshold; and
a determination means for determining a representative point of the group by using the representation indexes in the group, and determining a representative representation index based on the representative point.

### (Supplementary Note 2)

The information processing device according to Supplementary Note 1, further including
a selection means for selecting, from among a plurality of the groups, a group in which the number of representation indexes included in the group is equal to or more than a predetermined number,
in which the determination means determines the representative point of the group selected by the selection means.

### (Supplementary Note 3)

The information processing device according to Supplementary Note 1 or 2, in which the determination means determines, as the representative representation index, the representation index closest to the representative point from among a plurality of the representation indexes included in the group.

### (Supplementary Note 4)

The information processing device according to any one of Supplementary Notes 1 to 3, in which the determination means determines the representative point as the representative representation index.

### (Supplementary Note 5)

The information processing device according to any one of Supplementary Notes 1 to 4, in which
the representation indexes are representation vectors, and
the calculation means calculates a cosine similarity as the degree of similarity.

### (Supplementary Note 6)

The information processing device according to any one of Supplementary Notes 1 to 5, further including a representation extraction means for generating a plurality of the representation indexes based on the image.

### (Supplementary Note 7)

The information processing device according to Supplementary Note 6, in which
the representation extraction means:
divides the image into as many regions as a slot count; and
generates the representation index of each of the divided regions.

### (Supplementary Note 8)

The information processing device according to Supplementary Note 6 or 7, in which
the representation extraction means executes, for one of the images:
acquiring a list including at least a first slot count and a second slot count different from the first slot count;
dividing the image into as many regions as the first slot count and generating the representation index of each of the divided regions; and
further dividing the image into as many regions as the second slot count and generating the representation index of each of the divided regions.

### (Supplementary Note 9)

The information processing device according to Supplementary Note 8, in which the calculation means calculates the degree of similarity between the representation index generated based on the first slot count and the representation index generated based on the second slot count.

### (Supplementary Note 10)

The information processing device according to any one of Supplementary Notes 1 to 9, further including an object reconstruction means for generating a layer in which the object appears based on the representative representation index, and generating a reconstructed image in which the layer in which the object appears and a background layer are superimposed.

### (Supplementary Note 11)

A program for causing at least one processor to execute:
calculation processing of calculating, for each one of a plurality of representation indexes that represent regions included in an image and based on objects that appear in the image, each of the representation indexes having a different value, a degree of similarity with each of other representation indexes included in the plurality of representation indexes;
grouping processing of forming a group of the representation indexes in which the degree of similarity is higher than a predetermined threshold; and
determination processing of determining a representative point of the group by using the representation indexes in the group, and determining a representative representation index based on the representative point.

### (Supplementary Note 12)

An information processing method including:
a calculation step of calculating, by at least one processor, for each one of a plurality of representation indexes that represent regions included in an image and based on objects that appear in the image, each of the representation indexes having a different value, a degree of similarity with each of other representation indexes included in the plurality of representation indexes;
a grouping step of forming, by the at least one processor, a group of the representation indexes in which the degree of similarity is higher than a predetermined threshold; and
a determination step of determining, by the at least one processor, a representative point of the group by using the representation indexes in the group, and determining a representative representation index based on the representative point.

### (Supplementary Note 13)

The program according to Supplementary Note 11, further causing the at least one processor to execute selection processing of selecting, from among a plurality of the groups, a group in which the number of representation indexes included in the group is equal to or more than a predetermined number,
in which the determination processing includes causing the at least one processor to determine the representative point of the group selected in the selection processing.

### (Supplementary Note 14)

The program according to Supplementary Note 11 or 13, in which the determination processing includes causing the at least one processor to determine, as the representative representation index, the representation index closest to the representative point from among a plurality of the representation indexes included in the group.

### (Supplementary Note 15)

The program according to Supplementary Note 11, 13, or 14, in which the determination processing includes causing the at least one processor to determine the representative point as the representative representation index.

### (Supplementary Note 16)

The program according to any one of Supplementary Notes 11 and 13 to 15, in which
the representation indexes are representation vectors, and
the calculation processing includes causing the at least one processor to calculate a cosine similarity as the degree of similarity.

### (Supplementary Note 17)

The program according to any one of Supplementary Notes 11 and 13 to 16, further causing the at least one processor to execute representation extraction processing of generating a plurality of the representation indexes based on the image.

### (Supplementary Note 18)

The program according to Supplementary Note 17, in which
the representation extraction processing includes causing the at least one processor to:
divide the image into as many regions as a slot count; and
generate the representation index of each of the divided regions.

### (Supplementary Note 19)

The program according to Supplementary Note 17 or 18, in which
the representation extraction processing includes causing the at least one processor to, for one of the images:
acquire a list including at least a first slot count and a second slot count different from the first slot count;
divide the image into as many regions as the first slot count and generate the representation index of each of the divided regions; and
further divide the image into as many regions as the second slot count and generate the representation index of each of the divided regions.

### (Supplementary Note 20)

The program according to Supplementary Note 19, in which the calculation processing includes causing the at least one processor to calculate the degree of similarity between the representation index generated based on the first slot count and the representation index generated based on the second slot count.

### (Supplementary Note 21)

The program according to any one of Supplementary Notes 11 and 13 to 20, in which the at least one processor is further caused to execute object reconstruction processing of generating a layer in which the object appears based on the representative representation index, and generating a reconstructed image in which the layer in which the object appears and a background layer are superimposed.

### (Supplementary Note 22)

The information processing method according to Supplementary Note 12, further including
a selection step of selecting, by the at least one processor, from among a plurality of the groups, a group in which the number of representation indexes included in the group is equal to or more than a predetermined number,
in which the determination step includes the at least one processor determining the representative point of the group selected in the selection step.

### (Supplementary Note 23)

The information processing method according to Supplementary Note 12 or 22, in which the determination step includes the at least one processor determining, as the representative representation index, the representation index closest to the representative point from among a plurality of the representation indexes included in the group.

### (Supplementary Note 24)

The information processing method according to any one of Supplementary Notes 12, 22, and 23, in which the determination step includes the at least one processor determining the representative point as the representative representation index.

### (Supplementary Note 25)

The information processing method according to any one of Supplementary Notes 12 and 22 to 24, in which
the representation indexes are representation vectors, and
the calculation step includes the at least one processor calculating a cosine similarity as the degree of similarity.

### (Supplementary Note 26)

The information processing method according to any one of Supplementary Notes 12 and 22 to 25, further including a representation extraction step of generating, by the at least one processor, a plurality of the representation indexes based on the image.

### (Supplementary Note 27)

The information processing method according to Supplementary Note 26, in which
the representation extraction step includes the at least one processor:
dividing the image into as many regions as a slot count; and
generating the representation index of each of the divided regions.

### (Supplementary Note 28)

The information processing method according to Supplementary Note 26 or 27, in which
the representation extraction step includes the at least one processor executing, for one of the images:
acquiring a list including at least a first slot count and a second slot count different from the first slot count;
dividing the image into as many regions as the first slot count and generating the representation index of each of the divided regions; and
further dividing the image into as many regions as the second slot count and generating the representation index of each of the divided regions.

### (Supplementary Note 29)

The information processing method according to Supplementary Note 28, in which the calculation step includes the at least one processor calculating the degree of similarity between the representation index generated based on the first slot count and the representation index generated based on the second slot count.

### (Supplementary Note 30)

The information processing method according to any one of Notes 12 and 22 to 29, further including an object reconstruction step of generating a layer in which the object appears based on the representative representation index, and generating a reconstructed image in which the layer in which the object appears and a background layer are superimposed.

### [Supplementary Information 2]

The present disclosure includes the technologies described in the following Supplementary Notes. However, the present disclosure is not limited to the technologies described in the following Supplementary Notes, and various changes may be made without departing from the spirit and scope as defined by the claims.

### (Supplementary Note 1)

An information processing device including at least one processor, the at least one processor executing:
calculation processing of calculating, for each one of a plurality of representation indexes that represent regions included in an image and based on objects that appear in the image, each of the representation indexes having a different value, a degree of similarity with each of other representation indexes included in the plurality of representation indexes;
grouping processing of forming a group of the representation indexes in which the degree of similarity is higher than a predetermined threshold; and
determination processing of determining a representative point of the group by using the representation indexes in the group, and determining a representative representation index based on the representative point.

### (Supplementary Note 2)

The information processing device according to Supplementary Note 1, in which
the at least one processor further executes selection processing of selecting, from among a plurality of the groups, a group in which the number of representation indexes included in the group is equal to or more than a predetermined number, and
the determination processing includes the at least one processor determining the representative point of the group selected in the selection processing.

### (Supplementary Note 3)

The information processing device according to Supplementary Note 1 or 2, in which the determination processing includes the at least one processor determining, as the representative representation index, the representation index closest to the representative point from among a plurality of the representation indexes included in the group.

### (Supplementary Note 4)

The information processing device according to any one of Supplementary Notes 1 to 3, in which the determination processing includes the at least one processor determining the representative point as the representative representation index.

### (Supplementary Note 5)

The information processing device according to any one of Supplementary Notes 1 to 4, in which
the representation indexes are representation vectors, and
the calculation processing includes the at least one processor calculating a cosine similarity as the degree of similarity.

### (Supplementary Note 6)

The information processing device according to any one of Supplementary Notes 1 to 5, in which the at least one processor further executes representation extraction processing of generating a plurality of the representation indexes based on the image.

### (Supplementary Note 7)

The information processing device according to Supplementary Note 6, in which
the representation extraction processing includes the at least one processor:
dividing the image into as many regions as a slot count; and
generating the representation index of each of the divided regions.

### (Supplementary Note 8)

The information processing device according to Supplementary Note 6 or 7, in which
the representation extraction processing includes the at least one processor executing, for one of the images:
acquiring a list including at least a first slot count and a second slot count different from the first slot count;
dividing the image into as many regions as the first slot count and generating the representation index of each of the divided regions; and
further dividing the image into as many regions as the second slot count and generating the representation index of each of the divided regions.

### (Supplementary Note 9)

The information processing device according to Supplementary Note 8, in which the calculation processing includes the at least one processor calculating the degree of similarity between the representation index generated based on the first slot count and the representation index generated based on the second slot count.

### (Supplementary Note 10)

The information processing device according to any one of Supplementary Notes 1 to 9, in which the at least one processor further executes object reconstruction processing of generating a layer in which the object appears based on the representative representation index, and generating a reconstructed image in which the layer in which the object appears and a background layer are superimposed.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. An information processing device comprising:
at least one memory storing instructions; and
at least one processor configured to execute the instructions to:
calculate, for each one of a plurality of representation indexes that represent regions included in an image and based on objects that appear in the image, each of the representation indexes having a different value, a degree of similarity with each of other representation indexes included in the plurality of representation indexes;
form a group of the representation indexes in which the degree of similarity is higher than a predetermined threshold;
determine a representative point of the group by using the representation indexes in the group; and
determine a representative representation index based on the representative point.

2. The information processing device according to claim 1,
wherein the at least one processor is further configured to execute the instructions to:
select, from among a plurality of the groups, a group in which the number of representation indexes included in the group is equal to or more than a predetermined number; and
determine the representative point of the group selected.

3. The information processing device according to claim 1,
wherein the at least one processor is further configured to execute the instructions to:
determine, as the representative representation index, the representation index closest to the representative point from among a plurality of the representation indexes included in the group.

4. The information processing device according to claim 1,
wherein the at least one processor is further configured to execute the instructions to:
determine the representative point as the representative representation index.

5. The information processing device according to claim 1,
wherein the at least one processor is further configured to execute the instructions to:
calculate a cosine similarity as the degree of similarity, and the representation indexes are representation vectors.

6. The information processing device according to claim 1,
wherein the at least one processor is further configured to execute the instructions to:
generate a plurality of the representation indexes based on the image.

7. The information processing device according to claim 6,
wherein the at least one processor is further configured to execute the instructions to:
divide the image into as many regions as a slot count; and
generate the representation index of each of the divided regions.

8. The information processing device according to claim 6,
wherein the at least one processor is further configured to execute the instructions to:
for one of the images,
acquire a list including at least a first slot count and a second slot count different from the first slot count;
divide the image into as many regions as the first slot count;
generate the representation index of each of the divided regions;
divide the image into as many regions as the second slot count; and
generate the representation index of each of the divided regions.

9. The information processing device according to claim 8,
wherein the at least one processor is further configured to execute the instructions to:
calculate the degree of similarity between the representation index generated based on the first slot count and the representation index generated based on the second slot count.

10. The information processing device according to claim 1,
wherein the at least one processor is further configured to execute the instructions to:
generate a layer in which the object appears based on the representative representation index; and
generate a reconstructed image in which the layer in which the object appears and a background layer are superimposed.

11. A non-transitory recording medium recording a program for causing a computer to execute:
calculating, for each one of a plurality of representation indexes that represent regions included in an image and based on objects that appear in the image, each of the representation indexes having a different value, a degree of similarity with each of other representation indexes included in the plurality of representation indexes;
forming a group of the representation indexes in which the degree of similarity is higher than a predetermined threshold;
determining a representative point of the group by using the representation indexes in the group; and
determining a representative representation index based on the representative point.

12. An information processing method comprising:
by a computer,
calculating, by at least one processor, for each one of a plurality of representation indexes that represent regions included in an image and based on objects that appear in the image, each of the representation indexes having a different value, a degree of similarity with each of other representation indexes included in the plurality of representation indexes;
forming a group of the representation indexes in which the degree of similarity is higher than a predetermined threshold;
determining a representative point of the group by using the representation indexes in the group; and
determining a representative representation index based on the representative point.
